(19) United States
(12) Patent Application Publication
(10) Pub. No.: US 2015/0142982 A1
(43) Pub. Date: May 21, 2015

(54) PRESERVATION OF CONNECTION SESSION

(71) Applicant: Microsoft Corporation, Redmond, WA (US)

(72) Inventors: Darren Gonzales, Monroe, WA (US); Shri Vidhya, Sammamish, WA (US); Joseph Warren, Renton, WA (US); Allie Sousa, Redmond, WA (US); Darrell Brunsch, Sammamish, WA (US); Chris Knestrick, Redmond, WA (US); Robert Novitskey, Redmond, WA (US)

(73) Assignee: MICROSOFT CORPORATION, Redmond, WA (US)

(21) Appl. No.: 14/089,604

(22) Filed: Nov. 25, 2013

Related U.S. Application Data
(60) Provisional application No. 61/905,034, filed on Nov. 15, 2013.

(51) Int. Cl. H04L 29/06

(52) U.S. Cl. CPC H04L 65/1069
USPC 709/227

(57) ABSTRACT

Methods and systems are provided for connecting to a previously-created server session after a period of disconnection. The client is configured with the capability to maintain or establish a persistent session across a period of disconnection.

### CROSS-REFERENCE TO RELATED APPLICATION

The present application claims the benefit of U.S. Provisional Patent Application Ser. No. 61/905,034, filed Nov. 15, 2013, which application is hereby incorporated by reference in its entirety.

### BACKGROUND

In a communications environment, a client/server relationship is often used to interconnect services that may be distributed across different remote locations. Often times a user may execute an application locally on a client device and the application may retrieve data from a remote server connected to the client device over a network. In an example scenario, after a connection is established between the client device and the server, the application may forward a request to the server, and the server may in turn send a request to a database to retrieve requested data and information. The server may return the retrieved data to the client device which may display the information to the user and enable the user to interact with the data.

A communication protocol is used to facilitate communication between a local client to a remote server. Some protocols may require a persistent connection with the server for communicating, authenticating, and exchanging data. If the connection is lost, the client can reconnect, but the client has to establish a new session with the server. Other protocols do not require a persistent connection and instead periodically connect to the server (e.g., polling) for communicating, authenticating, and exchanging data. However, during each poll or if a connection is lost between the client and server using a polling protocol, the client has to establish a new session with the server. Accordingly, the client has to establish a new session every time the connection between the client and the server is lost.

It is with respect to these and other general considerations that embodiments have been made. Also, although relatively specific problems have been discussed, it should be understood that the embodiments should not be limited to solving the specific problems identified in the background.

### SUMMARY

In summary, the present disclosure relates to maintaining a session between a client and a server across a period of disconnection. In particular, the present disclosure relates generally to methods and systems for connecting to a previously-created session after a period of disconnection. The client is configured with the capability to maintain or establish a persistent session across different connectivity states.

In a first aspect, a method includes maintaining a session across a period of disconnection between a client and a server to exchange data over a network. The method includes:
determining that a disconnection between the server and the client is pause eligible based on a disconnection condition;
sending a context identifier to the server during a first reconnection attempt based on the determination; and
receiving a state of the session from the server in response to the sent context identifier.

In a second aspect, a system includes a computing system which has a client for data exchange with a server executed at least in part by a computing device. Further computing device has a programmable circuit and a memory containing computer-executable instructions. When executed, the computer-executable instructions cause the computing system to determine that a disconnection between the server and the client is pause eligible based on a disconnection condition, send a context identifier to the server during a first reconnection attempt, and resume a session with the server based on the receipt of a valid state of the session sent from the server in response to the context identifier.

In a third aspect, a computer-readable storage medium comprising computer-executable instructions stored thereon is disclosed. When executed by a computing system, the computer-executable instructions cause the computing system to perform a method. The method includes:
exchanging data in a session with a server over a network connection;
receiving a context identifier that identifies the session from the server;
storing the context identifier;
determining that a disconnection is pause eligible based on a disconnection condition;
sending the context identifier back to the server during a first reconnection attempt;
receiving a valid state of the session from the server in response to the sent context identifier; and
resuming the session, wherein the session provides access to any resource accessed prior to the disconnection.
   The disconnection condition is at least one of a hibernation, a change in interface, a loss of connectivity, password expiration, server-requested throttling, and no connectivity

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive embodiments are described with reference to the following Figures in which:

FIG. 1 illustrates an exemplary system where a client may access productivity and communication services over a network, according to an example embodiment;

FIG. 2 illustrates an exemplary system of data exchange between a client and a server employing an HTTP protocol, according to an example embodiment;

FIG. 3 illustrates an exemplary system of data exchanged between a client and a server to establish a session employing a HTTP protocol, according to an example embodiment;

FIG. 4 illustrates exemplary method for establishing a session between a client and a server to exchange data over a network and to restore the previously established session after a disconnection, according to an example embodiment;

FIG. 5 illustrates an exemplary method for resuming a session after a period of disconnection, according to an example embodiment;

FIG. 6 illustrates an exemplary method for establishing a new session for a client and server during the reconnection attempt illustrated in FIG. 5, according to an example embodiment;

FIG. 7 is a block diagram illustrating example physical components of a computing device with which embodiments of the disclosure may be practiced;

FIGS. 8A and 8B are simplified block diagrams of a mobile computing device with which embodiments of the present disclosure may be practiced; and

FIG. 9 is a simplified block diagram of a distributed computing system in which embodiments of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

Throughout this specification, the term “platform” may be a combination of software and hardware components for providing data exchange over a protocol between a client and a server and to over a network. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

As briefly described above, embodiments of the present disclosure are directed to maintaining a session between a client and a server after a disconnection. In particular, the present disclosure relates generally to methods and systems for connecting to a previously-created session after a disconnection. The client is configured with the capability to maintain or establish a persistent session across different connectivity states.

In a communications environment, a client/server relationship is often used to interconnect services that may be distributed across different remote locations. Often times a user may execute an application locally on a client device and the application may retrieve data from a remote server connected to the client device over a network. A protocol may be utilized to facilitate communication, authentication, and exchange of data between the client and the server. Some protocols may require a persistent connection with the server and some protocols may periodically connect to the server for communicating, authenticating, and exchanging data. During data exchange, a session is created and stored within the server. The session (also known as a context) as utilized herein refers to the one or more server resources that were accessed or requested by a client during data exchange between the client and server. After disconnection, the server retains the session for a predetermined amount of time. After the predetermined amount of time, the server deletes or invalidates the session.

Previously employed protocols and/or applications require a client to establish a new session after connection. In other words, the client has to restart a session to access resources on the server necessary for the application. Previously, the client was not able to reconnect to the saved session on the server and had to invalidate or delete accessed (such as opened) client side resources. Accordingly, any edits or changes that were made by an end user and/or a client before the disconnection, and that were not saved before the disconnection, were lost and not saved. For example, if a user was drafting an email which was not saved, upon a network disconnection, the drafted email is lost or cannot be saved and/or recovered after reconnection.

To address the above limitations, embodiments of the present disclosure allow clients to maintain or establish a persistent session with a server across disconnections. The persistent session may remain active upon a period of disconnection. As such, embodiments disclosed herein allow a client to reconnect with a server and, in doing so, provide access to a previously created session on the server. In embodiments, the client receives a session identifier or context identifier that identifies a created session from the server during data exchange and/or upon creation of the session. In embodiments, a data communication protocol, also referred to herein as a “protocol,” can include, but are not limited to, the Remote Procedure Call (RPC) protocol, the Hypertext Transfer (HTTP) protocol, the Post Office Protocol (POP3), the Internet Message Access Protocol (IMAP), etc. One of skill in the art will appreciate that any type of communication protocol can be employed with the various embodiments disclosed herein. The client may utilize the session identifier or context identifier to reconnect with the server. The context identifier or session identifier authenticates the client and provides access to resources (such as objects) that were accessed during the session in the previous connection between the client and the server. Accordingly, resuming a connection between the server and the client after a pause requires less time and bandwidth when compared to the previously utilized connection process that requires establishment of a new session. application Ser. No. 13/956,014, entitled MESSAGING API OVER HTTP PROTOCOL TO ESTABLISH CONTEXT FOR DATA EXCHANGE, filed on Jul. 31, 2013 and application Ser. No. 13/955,863, entitled MESSAGING OVER HTTP PROTOCOL FOR DATA EXCHANGE, filed on Jul. 31, 2013, both of which are incorporated by reference herein in their entirety, further discuss systems and methods for using a context identifier to resume a session over a protocol.

However, in embodiments, not all disconnection conditions allow for or are ideal for the use of a session identifier or context identifier for reconnection. In embodiments, a disconnection condition that is eligible for use of the context identifier to resume a session is referred to herein as a pause. A disconnection condition that is not eligible for use of the context identifier to resume a session is referred to herein as a full disconnection or fully disconnected. In embodiments, various scenarios may dictate whether a disconnection is a pause or a full disconnection. Accordingly, the embodiments disclosed herein allow a client to determine if a disconnection is eligible for use of the context identifier for reconnection with an established session. Embodiments disclosed herein may be operable to determine whether a disconnection is pause eligible based on a disconnection condition. The disconnection condition may be an event that caused the disconnection or a state of data exchange at the time of disconnection.

In embodiments, the pause state may be used under circumstances in which lightweight operations are all that is required such as, for example, situations that do not require calls to server-side functions. Accordingly, when the client resumes a connection from the pause state, the server session and the associated resources are still valid and accessible (e.g., because they have not been modified or deleted while the client was disconnected from the server). Because the resources are still valid, the client is not required to invalidate or delete client side resources prior to reconnecting to the server.

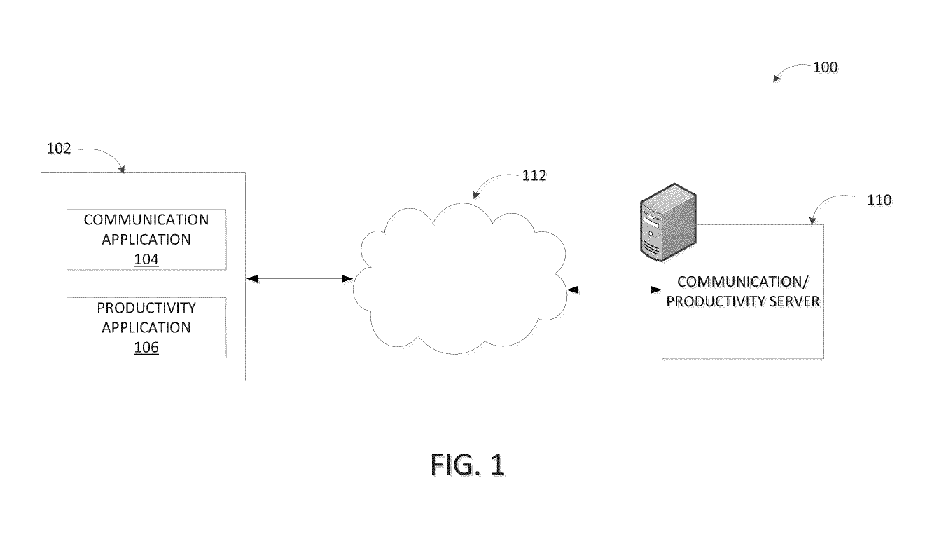

FIG. 1 illustrates an example system 100 where a client device 102 may access productivity and/or communication services over a network, according to some embodiments disclosed herein. The computing devices and computing environments shown in FIG. 1 are for the sake of illustration. One of skill in the art will appreciate that the embodiments disclosed herein may be implemented in various local, networked, and similar computing environments employing a variety of computing devices and systems.

As illustrated in system 100, a client device 102 may employ a variety of different applications for exchanging and/or interacting with data. Example applications executed at a client device for interacting with data may be one or more productivity applications 106 (e.g., a word processor, a presentation applications, a spreadsheet application, etc.) and one or more communication applications 104 (e.g., email applications, instant messaging applications, video streaming applications, etc.) or any applications that require a client device and a server to communication (e.g., banking applications, internal company applications, and etc.). Example client devices 102 may include a desktop computer, a laptop computer, a tablet, a smart watch, a wearable computer, a mobile phone, a smartphone, an electronic whiteboard, and/or other similar client devices. The communication service and the productivity service may also work in conjunction to retrieve and exchange email and other data. Additionally, while FIG. 1 illustrates a single client 102 and server 110, one of skill in the art will appreciate that embodiments of the present disclosure may include multiple client devices interacting with multiple servers 110.

An example productivity application 106 may be configured to provide access to various services built around a productivity platform. In embodiments, the services may be locally executed or hosted on a remote device, such as server 110. Some productivity services may include, but are not limited to, a collaboration application, an enterprise management application, a messaging application, a word processing application, a spreadsheet application, a database application, a presentation application, etc. The productivity service 106 may provide access to data associated with the various productivity applications hosted on a remote device by retrieving the data, for example, from a remote server 110. The server 110 may be accessed over a network 112, which may be a wired or wireless network, or a cloud network, and the retrieved data may be loaded, manipulated, or otherwise accessed at a user's local client device executing the productivity service 106. Exemplary networks may include, but are not limited to, cellular data networks, working area networks (WANs), local area networks (LANs), and the Internet.

Similarly, an example communication application 104 may be an application or service configured to provide email, contacts management, and/or calendar services. In embodiments, the communication application 104 may also provide one or more real-time communications platforms, such as instant messaging, audio/visual conferencing, and presence detection. For example, a user may receive, view and reply to emails using the communication application 104 executed on the client 102.

The services and/or functionality provided by the communication application 104 and the productivity application 106 may be hosted at an external server capable of communicating or otherwise exchanging data with the communication application 104 and/or the productivity application 106, and a user may access the provided services and/or functionality locally at a client device 102 over the network 112. Additionally, data may be exchanged between the local client device and the server over the network 112, such that the local client device may have an active connection with the server 110 over the network to access and interact with data provided by the communication application 104 and the productivity application 106.

The client 102, using communication application 104, the productivity application 106, or other types of applications or processes may issue a number of requests to the server 110 to retrieve data stored on the server 100 or stored in a data store accessible by the server 110. Each time the local client requests data from the server 110, the client may have to authenticate itself with the server. Additionally, if the connection between the client and the server 110 is dropped or changed during the data request and exchange, the client may have to re-authenticate itself with the server to re-establish the connection for data exchange. In a system according to embodiments, a session may be established between the client and the server 110 during an initial data request, and the session identified by a context identifier may be used as a basis of authentication for subsequent data retrieval requests. After a disconnection, the context identifier may be utilized for authentication and to resume a session created during the last connection.

The term “session” (or “context”) as used herein may represent a collection of state on the server that is held between unique client requests and may be referenced using a context identifier (such as a cookie (i.e., context cookie), or other identifier) returned when the “session” was created and on each subsequent response. In embodiments, the collection of state information may be uniquely specific to server implementation and not specifically identified or defined within the protocol itself as it is never transmitted across the wire. The collection of state information may also not be tied to any physical or logical connection between the client and the server. As such, in embodiments a client may be free to issue subsequent requests to the server identifying the “session” via a context identifier on any newly established connections independent of the connection in which the “session” was initially created (e.g., by using other connection methods and/or protocols).

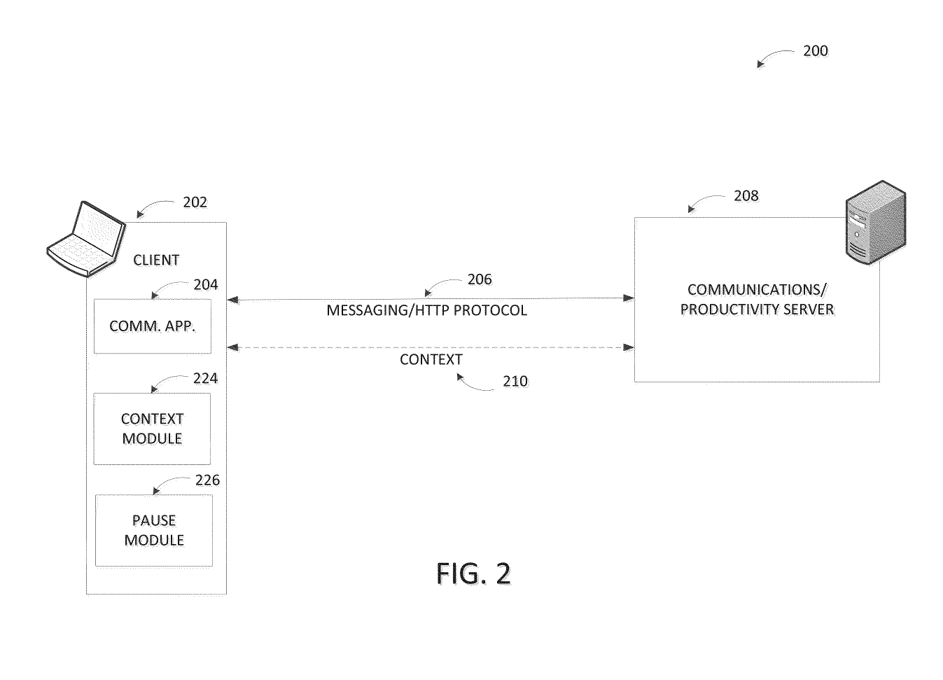

FIG. 2 illustrates an example data exchange between a client and a server employing an HTTP protocol, according to some embodiments described herein. In alternative embodiments, a protocol other than the HTTP protocol may be employed between the client and server for data exchange. One of skill in the art will appreciate that any communication protocol may be employed by the embodiments disclosed herein (e.g., RPC, POP3, IMAP, etc.).

As illustrated in system 200, a client 202 may execute an application 204, such as a productivity application, a communication application, or other type of application, such as an email application, contacts application, a calendar management application, etc., on the client 202. The client 202 may communicate with a server 207 over a network (not shown) to retrieve data associated with the application 204 such as, for example, email data. One of skill in the art will appreciate that the type of data being accessed over the network may vary depending on the type of application 204 executing on the client 202.

In system 200, a connection may be established between the client 202 and the server 207 in order to enable data, messages, and/or information to be exchanged between the client 202 and server 207. The client 202, via application 204 or via another component, may initiate a connection with the server 207 via a network and may request data from the server 207. The server 207 may accept the request, process the request, and return the requested information to the client 202. During the initial request, a context identifier 210 may be created to identify the established session between the client 202 and the server 208 to authenticate the client 202 for subsequent data retrieval requests. A context module 224 of the client 202 saves this context identifier 210 and utilizes this context identifier 210 to identify the session for subsequent data retrieval requests.

In an example embodiment, the HTTP protocol may be employed to facilitate communication, authentication, and exchange of data between the client 202 and the server 207. The HTTP protocol defines methods, commands, requests, and/or messages, which may be used to indicate a desired action to be performed by the server to retrieve requested information for client 202. While specific HTTP methods are described herein, one of skill in the art will appreciate that other HTTP methods, or commands defined by communications protocols other than the HTTP protocol may be employed with the embodiments disclosed herein.

In an example embodiment, the client 202 may incorporate a communication protocol 206 in order to facilitate communication of data related to the application 204 (or other data) between the client 202 and the server 207 via a network. For example, in embodiments the HTTP protocol may enable the client 202 to send a request to the server 207 over an HTTP connection and to receive a response from the server 207 over the same HTTP connection. The HTTP protocol 206 may also enable the client 202 to create a context identifier 210 to identify an established session with the server 208 over the HTTP connection for authenticating the client during future requests. Furthermore, the client 202 may open additional HTTP connections with the server 208 to send concurrent independent requests to the server 208.

When a connection is broken or when the client 202 determines that a connection is about to end, a pause module 226 of the client 202 determines if the disconnection condition is pause eligible. A disconnection condition may refer to the event that caused or led to the disconnection and/or a state of data exchange at the time of disconnection. In some embodiments, the disconnection condition may be an invalid state of the session, an incomplete client request at the time of disconnection, an outstanding server requests at the time of disconnection, hibernation, a change in interface, a loss of connectivity, password expiration, server-requested throttling, and/or no connectivity. The disconnection condition may be either pause eligible or pause ineligible. The disconnection is considered a pause (and may resume a session) when the condition is a pause eligible condition. The disconnection is considered a full disconnection (requires establishing a new session), when the condition is a pause ineligible condition. When the pause module 226 determines that disconnection between the client 202 and the server 208 is a full disconnection, the client 202 utilizes connections procedures that require establishment of a new session to reconnect to the server 208. When the pause module 226 determines the disconnection between the client 202 and the server 208 is a pause, the client 202 utilizes a context identifier that identifies an established session to resume a connection with the server 208.

In some embodiments, the pause module 226 may compare the condition of disconnection to a list of pause ineligible disconnection conditions. In some embodiments, a pause ineligible condition is an invalid state of the session, an incomplete client request at the time of disconnection, and/or an outstanding server requests at the time of disconnection. The use of a list of pause ineligible conditions provides that the client 202 defaults to a pause state unless a pause ineligible condition is detected. In these embodiments, if the disconnection condition is on the list of pause ineligible conditions, the pause module 226 determines that the disconnection between the client 202 and server is considered a full disconnection (instead of a pause). In these embodiments, if the pause module 226 of the client 202 determines that the condition is not on the list of pause ineligible conditions, the pause module 226 determines that the disconnection between the client 202 and server 208 is considered a pause (instead of a full disconnection).

In other embodiments, the pause module 226 may compare the condition of disconnection to a list of pause eligible disconnection conditions. In some embodiments, the pause eligible condition is hibernation, a change in interface, a loss of connectivity, password expiration, server-requested throttling, and/or no connectivity. In these embodiments, if the disconnection condition is not on the list of pause eligible conditions, the pause module 226 determines that the disconnection between the client 202 and server is considered a full disconnection (instead of a pause). In these embodiments, if the pause module 226 of the client 202 determines that the condition is on the list of pause eligible conditions, the pause module 226 determines that the disconnection between the client 202 and server 208 is considered a pause (instead of a full disconnection).

When the disconnection between the client 202 and server 208 is considered a pause, the context module 224 sends a context identifier 210 identifying the session during the reconnection attempt with the server 208. The sent context identifier 210 was received by the client 202 during the previously established session prior to disconnection. In some embodiments, the context identifier is created and sent by the server to the client at the start of the session. The context identifier may contain a session identifier, state information, authentication information, and/or any other information necessary for resuming a previous session. In some embodiments, the context identifier is a cookie. The server 208 evaluates the context identifier 210 to determine if the session identified by the context identifier is valid. If the session is valid, the server 208 sends a notice to the client 202 that the state of the session is valid (i.e., valid state). A connection between the client 202 and server 208 is formed and the server 208 allows the client 202 to access and/or utilize a previously created session (e.g., access objects or resources opened or otherwise accessed by the client during the last connection). If the session is invalid, the server 208 sends a notice to the client 202 that the state of the session is invalid. The pause module 226 of the client 202 changes the disconnection state from a pause to a full disconnection based on the receipt of an invalid session state. As discussed above, once a client 202 determines that a connection is a full disconnection, the client 202 has to utilize the previous connection process that requires establishment of a new session (e.g., accessing each needed server object) to reconnect to the server 208. In some embodiments, the session is invalid if the server 208 has deleted the previous session. A server 208 may delete or invalidate a session after a predetermined amount of time.

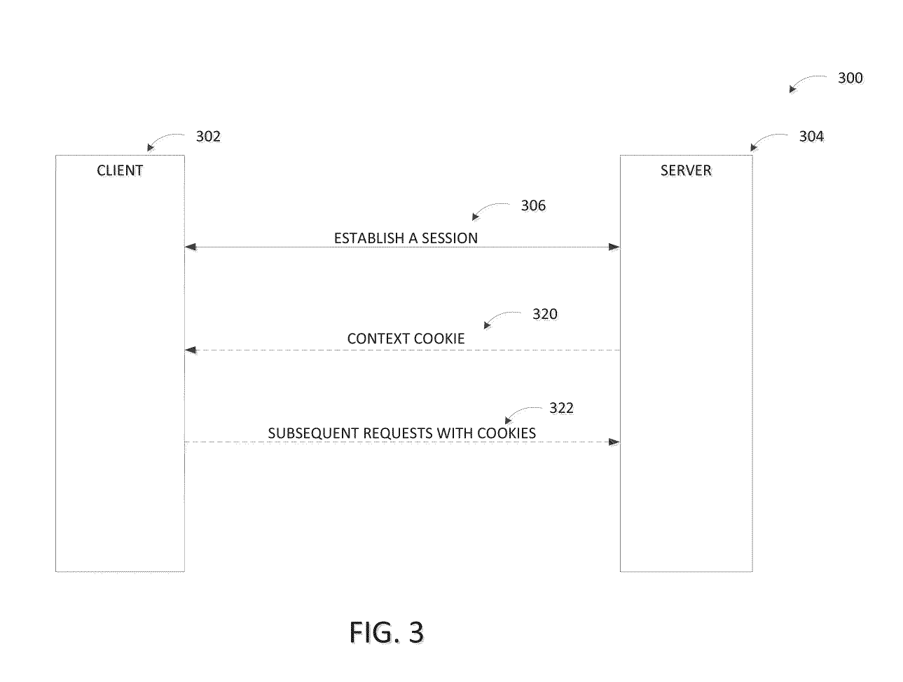

FIG. 3 illustrates example data requests and responses exchanged between a client and a server to establish a session employing a HTTP protocol, according to some example embodiments. In the illustrated embodiment, the HTTP protocol is illustrated. However, other communications protocols may be employed without departing from the scope of the present disclosure.

As previously described in conjunction with FIG. 2, a client 302 may utilize a standardized HTTP request in order to request data from a server 304 associated with an application executed at the client 302. The HTTP protocol may also be configured to establish a session between the client 302 and the server 304 to authenticate the client 302 to the server for future data requests.

As illustrated in diagram 300, a first session is established 306. The first session is established by the client 302 sending credentials to the server 304, the server authenticating those credentials, and the client sending one or more requests to access any needed resource (such as an object).

In a system according to embodiments, the server 304 may also generate a context identifier, such as a cookie (or other identifier) to identify the client 302 and to identify and/or resume a session of the client 302 with the server 304. The server 304 may return the context identifier or cookie to the client 302 with a response and/or with intermediary chunk responses in order to establish the session between the client 302 and the server 304. The server 304 may define the context identifier name and value according to server policies.

An example response from the server 304 to the client 302 including the generated context identifier (a cookie in this embodiment) may be as follows:

### HTTP/1.1 200 OK

Host: mail.contoso.com
Transfer-Encoding: chunked
Content-Type: application/mapi-http
Set-Cookie: MapiContext=<opaque string>
Set-Cookie: MapiSequence=<opaque string>

### X-RequestType: Connect

X-ResponseCode: <value>

### <Raw Binary Response Body>

For example, the context identifier is listed as: Set-Cookie: MapiContext=<opaque string>.

Upon receiving the context identifier 320, the client 302 may store the context identifier for future interactions with the server 304. When the client sends subsequent data requests to the server 304, the client 302 may include the context identifier in the subsequent request 322.

An example subsequent HTTP protocol data operation including the received context identifier (a cookie in this embodiment) may be as follows:

POST/<endpoint>/?MailboxId=<GUID>@contoso.com HTTP/1.1
Host: mail.contoso.com
Content-Length: <length>
Content-Type: application/mapi-http
Cookie: MapiContext=<opaque string>
Cookie: MapiSequence=<opaque string>

### X-RequestType: EcDoConnectEx

X-ClientInfo: <opaque string>

### X-RequestId: <GUID>:<ID>

### <Raw Binary Request Body>

In an example embodiment, since the client 302 stores the context identifier and returns the context identifier during subsequent requests, the client 302 may not have to establish a new session with the server 304 during each subsequent data request. The client 302 may provide the context identifier to the server 304, and the server may authenticate the client based the context identifier and may automatically validate that the session represented by the context identifier. The server 304 may return the requested data to the authenticated client 302 in a final response.

In a system according to embodiments, the context identifier may enable the session between the client and the server to be preserved in the event of a lost connection. For example, an HTTP connection may be lost when the client goes out of range, disconnects, changes connections, or goes into a hibernation mode. The client may still maintain the context identifier and/or accessed resource during the disconnection, and upon reconnection, the client 302 may provide the context identifier (that identifies the session) and/or accessed resources to the server 304 when the client 302 initiates a data request. The server 304 may be configured to store the session associated with the context identifier for a period of time, such that the client 302 may have some time to re-establish the connection with the server 304 before the context identifier expires. After the defined period of time, the session may expire, and the client 302 may have to authenticate itself at the server 304 during a data request. A new context identifier (such as a cookie) may be generated by the server and exchanged with the client to establish a new session.

However, the client 302 may not want to use a previously established session identified by the stored context identifier to reconnect to the server during all disconnections. Accordingly, the client 302 determines if the disconnection condition is pause eligible. In some embodiments, the client 302 compares the disconnection condition to a list of pause ineligible disconnection conditions. If the client determines that the disconnection condition is not pause eligible, the client 302 utilizes the previous connection process that requires establishment of a new session to connect to the server 308 instead of using the context identifier. If the client determines that the disconnection condition is pause eligible, the client 302 utilizes the context identifier to resume a connection instead of utilizing the previous connection process. In some embodiments, the disconnection condition may be an invalid state of the session, an incomplete client request at the time of disconnection, an outstanding server requests at the time of disconnection, hibernation, a change in interface, a loss of connectivity, password expiration, server-requested throttling, and/or no connectivity. In some embodiments, a pause ineligible condition includes an invalid state of the session, an incomplete client request at the time of disconnection, outstanding server requests at the time of disconnection, and/or any other unknown error condition. In other embodiments, disconnections that results because of hibernation, a change in interface, a loss of connectivity, password expiration, server-requested throttling, and/or no connectivity are pause eligible (or suitable for using the context identifier to connect the server).

In some embodiments, the disconnection between the server 304 and the client 302 is initiated by the client 302. For example, in some embodiments, the client 302 may determine that a better interface is available than the currently used interface. For example, a laptop using a wireless connection may determine after plugging in to a wired connection that the wired connection is a better interface or vice versa. A switch in interface is a pause eligible condition. Accordingly, the client 302 may choose to disconnect/pause from the server, switch to the better interface, and then resume the connection utilizing the context identifier that identifies the session.

In an example embodiment, the period of time for preserving the session may be predefined, and may also be configurable based on a network type, a client type, client devices associated with user, security parameters, and other similar parameters. The period of time for preserving the session may also be dynamic based on available resources at the server. For example, if only one client is interacting with the server 304, the server may preserve the session for a longer period of time because the client is not consuming a lot of server resources. If there are multiple users or clients interacting with the server 304, the server 304 may limit the number of preserved sessions and the time for preserving the sessions to preserver server resources. The server 304 may also communicate with the client 302 to tell the client 302 when the session will be expired. The client 302 may be able to refresh the established session to prolong a period of time of preservation for the session by communicating with server. For example, each time the client 302 actively communicates with the server 304, the server 304 may refresh the expiration time of the session. After a session is expired, the session may be permanently discarded at the server 304.

The example systems in FIG. 1 through 3 have been described with specific configurations, applications, and interactions. Embodiments are not limited to systems according to these examples. A system for providing a communication connection to establish a session between a client and a server and to exchange data over a network may be implemented in configurations employing fewer or additional components and performing other tasks. Furthermore, specific protocols and/or interfaces may be implemented in a similar manner using the principles described herein.

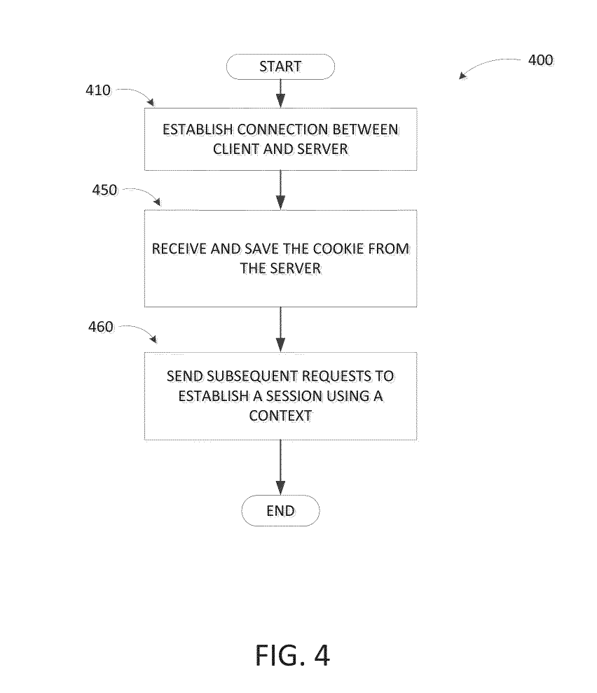

FIG. 4 illustrates an exemplary method for establishing a session between a client and a server and to exchange data over a network and to restore the previously established session after a disconnection according to an example embodiment. Method 400 may be implemented on a computing device or similar electronic device capable of executing instructions through a processor.

Method 400 begins with operation 410, where a connection may be established between a client and server. A client may be a device or an application, such as a productivity service and/or a communication service accessing information and data from a remote server over a network, such as a cloud network.

The server may generate a context identifier (such as a cookie) representing a session between the client and the server. The session may identify the client at the server during subsequent data requests. At operation 450, the client receives a generated context identifier that identifies the session from the server and saves the context identifier and/or the session. The context identifier and/or session may be maintained by the client during dropped and transferred connections, and during hibernation of the client. In an alternate embodiment, the client may generate the context identifier and send it to the server. At operation 460, the client sends subsequent requests to the server including the context identifier. The server may automatically validate the session as being from the same authenticated client based on the received context identifier.

The operations included in method 400 are for illustration purposes. Establishing a session between a client and a server and to exchange data over a network may be implemented by similar processes with fewer or additional steps, as well as in different order of operations using the principles described herein.

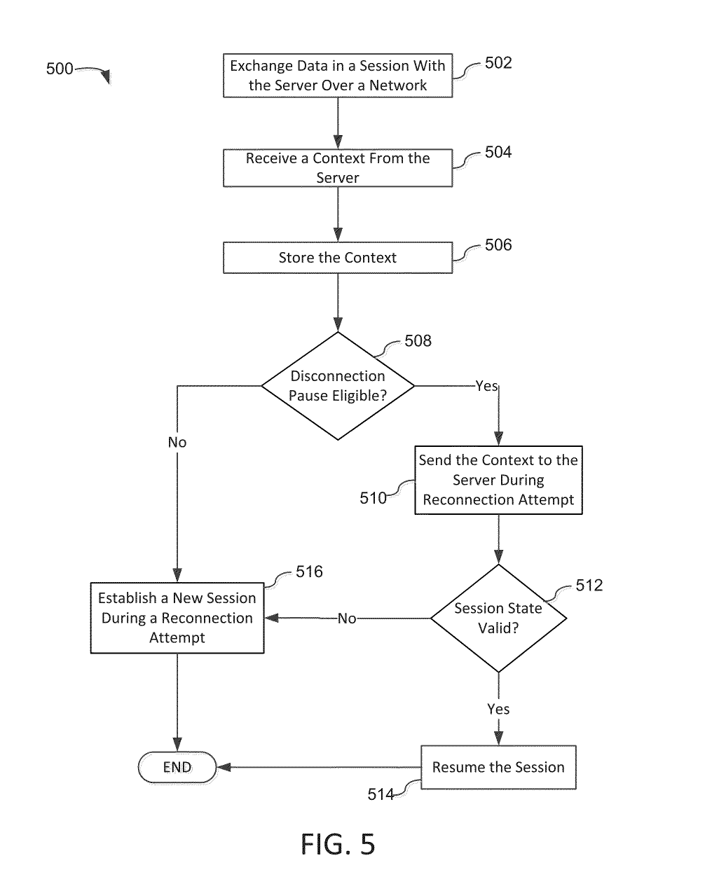

Referring now to FIG. 5, an exemplary method for resuming a session after a period of disconnection, according to an example embodiment is shown. The method 500 may be implemented by a client or an application executing on a client according to the embodiments disclosed herein. Further, the client or an application executing on a client performing the method 500 according to the embodiments disclosed herein may be configured with the capability to connect to a previously-created server session after a period of disconnection. In embodiments, a client executing method 500 may include, but is not limited to, a desktop computing device, a personal computer, a tablet, wearable computer, a smart watch, mobile phone, a smartphone, an electronic whiteboard, and other similar client devices. In some embodiments, the protocol is an RPC protocol or HTTP protocol. One of skill in the art will appreciate that many different types of protocols may be employed without departing from the spirit of the present disclosure.

In the embodiment shown, method 500 includes a communicating operation 502. In embodiments, during operation 502, the client or application performing the method 500 communicates with a server using a communication protocol. Any type of communication protocol may be employed. In some embodiments, the client communicates with the server during operation 502 to access information for an email application, a social networking application, a collaboration application, an enterprise management application, a messaging application, a word processing application, a spreadsheet application, a database application, a presentation application, and a contacts application, and/or a calendaring application. In some embodiments, the client-server system is utilized to synchronize items in a mailbox, such as email, calendar, and/or contacts. However, the method 500 may be applicable to any client-server system for which a server-side session should be maintained.

Next, flow continues to receiving operation 504. At receiving operation 504, the client or application performing the method 500 receives a context identifier from the server. As discussed above, the context identifier may be a cookie or any other session identifier that identifies a collection of state on the server that is held between unique client requests. In alternate embodiments, the client may provide the context identifier to the server.

Flow continues to storing operation 506. At storing operation 506, the client or application performing the method 500 stores the received context identifier and/or accessed resources. In some embodiments, the client stores the context identifier and/or accessed resources for a predetermined amount of time. In other embodiments, the client stores the context identifier and/or accessed resources until the session is invalidated by the server, for example, upon expiration of an amount of time or upon fulfillment of a condition. In some embodiments, the context identifier is stored until a full disconnection state is determined. However, the client may store the context identifier and/or accessed resources for any desired amount of time.

Flow continues to pausing decision operation 508. At pausing decision operation 508, the client or application performing the method 500 determines if a disconnection between the server and the client is pause eligible based on a disconnection condition. If a determination is made that the disconnection is not pause eligible, flow branches No to operation 516. If a determination is made that the disconnection is pause eligible, flow branches Yes to sending operation 510. A disconnection condition may refer to the condition that caused or led to the disconnection and/or a state of data exchange at the time of disconnection. In embodiments, the disconnection condition is a hibernation, a change in interface, a loss of connectivity, no connectivity, an invalid state of the session, an incomplete client request at the time of disconnection, and/or an outstanding server requests at the time of disconnection.

In some embodiments, the client compares the disconnection condition to a list of pause ineligible disconnection conditions to determine if a condition is pause eligible. In some embodiments, a pause ineligible disconnection conditions include an invalid state of the session, an incomplete client request at the time of disconnection, and/or an outstanding server requests at the time of disconnection. In some embodiments, the client compares the disconnection condition to a list of pause eligible disconnection conditions to determine if a condition is pause eligible. In embodiments, pause eligible disconnection conditions include hibernation, a change in interface, a loss of connectivity, password expiration, server-requested throttling, and/or no connectivity are pause eligible (or suitable for using the context identifier to connect the server). These lists are not limiting and one of skill in the art understands that the pause eligible and pause ineligible conditions may change based on the device, application, protocol, network, and/or server.

At sending operation 510, the client or application performing the method 500 sends a context identifier to the server during a first reconnection attempt. The server evaluates the context identifier to determine if the session is valid. If the session is valid, the server sends notice to the client that the state of the session is valid (i.e., valid state). If the session is invalid, the server sends notice to the client that the state of the session is invalid (i.e., invalid state). A session is valid if the server can authenticate the context identifier and access the previously created session referenced in the context identifier. After a predetermined amount of time, the server may invalidate or delete a session, which may invalidate a session and/or context identifier (such as a cookie).

Flow continues to state decision operation 512. At state decision operation 512, the client or application performing the method 500 monitors for the session state sent from the server. If a valid session state is received from the server, flow branches Yes to resuming operation 514 and the disconnection is considered a pause. If a valid session state is not received (or an invalid session state is received) from the server, flow branches No to establishing operation 516 and the disconnection is considered a full disconnection.

At resuming operation 514, the client or application performing the method 500 resumes the session. The client or application performing the method 500 may resume the session created during the previous connection because the disconnection is considered paused and not fully disconnected. The resumed session provides the client access to one or more resources, such as resources, accessed by client request prior to the disconnection. Further, because the session was resumed, edits to an application made before the pause can be saved after the session is resumed. For example, if edits were made to an email that was not saved prior to a pause, those edits may be saved and are not lost when the session is resumed. Accordingly, the devices or applications performing operation 514 during the method 500 do not have to establish a new session after connection (e.g., find and/or re-access necessary resources on the server).

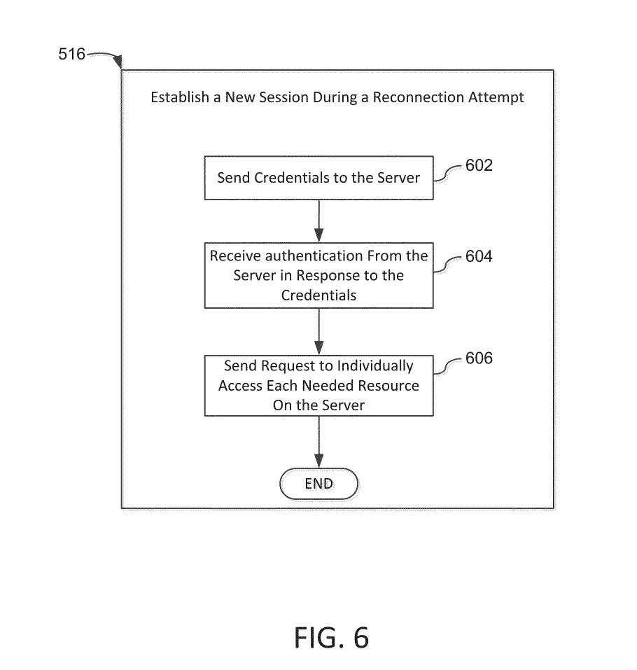

At establishing operation 516, the client or application performing the method 500 establishes a new session during a second reconnection attempt. The client or application performing the method 500 may establish a new session because the disconnection is considered a full disconnection. At establishing operation 516, the client or application performing the method 500 establishes a new session during a second reconnection attempt utilizing any known session creating systems or methods. In some embodiments, establishing operation 516 may perform sending credentials operation 602, receiving authentication operation 604, and/or sending open request operation 606 to establish a new session during a second reconnection attempt. FIG. 6 illustrates an exemplary method for establishing a new session between a client and server during the operation 516 illustrated in FIG. 5, according to an example embodiment At establishing operation 602, the client or application performing the operation 516 sends credentials to the server. The server reviews the credentials and notifies the client if the client has been authenticated or not. Flow continues to authentication operation 604. At operation 604, the client or application performing the operation 516 receives authentication from the server in response to the credentials. Next, flow continues to sending open request operation 606. At operation 606, the client or application performing the operation 516 sends one or more requests to individually access each needed resource on the server.

The reestablished session resulting from the performance of operation 516, does not provide the client with access to any resources accessed during a session prior to the disconnection. Further, because the session was reestablished (resulting from the performance of operation 516), edits to an application made before the full disconnection cannot be saved and are lost after the session is reestablished. In contrast to operation 514 discussed above, if edits were made to an email that was not saved prior to a full disconnection, those edits are lost and not savable when the session is reestablished. Accordingly, the devices or applications performing operation 516 during the method 500 have to re-authenticate themselves to reconnect with the server. Further, the devices or applications performing operation 516 during the method 500 have to establish a new session after the connection is reestablish and re-access, individually, any necessary resources on the server. Furthermore, a context identifier may be provided for the newly established session. This context identifier may be used to reconnect to the newly established session after a disconnect event.

In one example embodiment, the performance of method 500 includes the following example. When the connection between client and server is dropped for whatever reason, the client may reconnect with the existing session (or a session context) by sending a connect request that includes the context (or existing session cookies) that identifies the existing session saved by the client. If the previous session is still valid on the server, the server may destroy the session before creating a new session. The server may return a new context identifier that is associated with a new session. The server may ignore a sequence validation cookie (or valid state) passed in the reconnect scenario. The response from the server may use a set-context header or set-cookie header to pass any required context identifiers, resources, and/or cookies to the client. The response may pass the content-length header. As with any new session, the client may store all returned cookies, resources and/or context identifiers and may not comingle the new cookies, resources, and/or context identifiers with cookies, resources, and/or context identifiers from the previous session. If the session has expired, is no longer valid, or is not valid for the server in which the mailbox currently resides, then the server may fail the request with an X-ResponseCode value of 10, and the client may reconnect and establish a new session.

In another example embodiment, the performance of method 500 includes the following example. The server may return cookies, resources, and/or a context identifier used to identify the session that has been created. The client may store all returned cookies, resources, and/or context identifiers and associate them with the session. The client may include all cookies, resources, and/or context identifiers received from the previous call to the server for a given session when issuing the next request to the server for that session. If the server uses a session sequence cookie to guarantee the sequencing of requests, the client may pass this cookie, along with the context identifier, to the server on the next request. The cookie header may be used to pass the cookies.

In an additional example embodiment, the performance of method 500 includes the following example. To reconnect with an expired session, the client may send a new request using the connect request type, along with the connect request type request body. The only difference between reconnecting and an initial connection is that the client may pass all existing cookies, context identifier, and/or resource requests that are associated with the expired session. If the client reconnects, the client may pass any cookie values or resources it has stored for the session to which it is attempting to reconnect. A client may do this if the end user forcefully reconnects. This allows the server to clean up the previous context identifier in a timely fashion to prevent session limits from being reached. The reconnection request may look very much like a request to establish a new session, with the exception of passing all existing cookies, context identifiers, and/or resource requests that are associated with the expired session. Since the client may not be aware of the semantic meaning of the cookies, context identifiers, and/or resource request, the client may always pass all cookies, context identifiers, and/or resource request that the client has that relate to the specific session. Further during this example, the client may always assume the session is still valid. If the client is unable to communicate with the server, no matter how much time has passed, when the client finally re-establishes an HTTP connection the client may continue where the client left off.

In a further example embodiment, the performance of method 500 includes the following example. In this embodiment, the client may establish a new session with the server before sending or receiving emails. The client sends a request using an X-RequestType header field value of connect and includes the connect request type request body as illustrated below:

Client request

POST <Autodiscover-provided endpoint> HTTP/1.1
Host: <URL of the host server>
Content-Length: <length of REQUEST BODY>
Content-Type: application/mapi-http
X-RequestType: Connect
X-ClientInfo: <opaque string>
X-RequestId: <unique identifier>
X-ClientApplication: <client version>
<REQUEST BODY>

The server may process the request and may return a response that includes the session context identifier that identifies the new session, and the connect request type success response body as illustrated below:

Server response

HTTP/1.1 200 OK
Host: <URL of the host server>
Content-Length: <length of RESPONSE BODY>
Content-Type: application/mapi-http
Set-Cookie: <session context cookie>=<opaque string>
Set-Cookie: <request sequence cookie>=<opaque string>
X-RequestType: Connect
X-RequestId: <unique identifier>
X-ResponseCode: 0
X-ClientInfo: <opaque string>
X-ServerApplication: <server version>
X-ExpirationInfo: <milliseconds>
PROCESSING<CLRF>
DONE<CRLF>
X-ResponseCode: 0
X-ElapsedTime: <milliseconds>
X-StartTime: <date/time>
<CRLF>
<RESPONSE BODY>

In another example embodiment, the performance of method 500 includes the following example. This embodiment describes re-establishing a timed-out session. This is similar to the process of establishing a new session, but headers (such as cookie headers) may be passed with the context identifier associated with the expired session. A new context identifier may be passed back in the response for the re-established session using the set header (such as set-cooking header) An example client request and response is shown below:

Client request
POST <Autodiscover-provided endpoint> HTTP/1.1
Host: <URL of the host server>
Content-Length: <length of REQUEST BODY>
Content-Type: application/mapi-http
Cookie: <session context cookie>=<opaque string>
Cookie: <request sequence cookie>=<opaque string>
X-RequestType: Connect
X-ClientInfo: <opaque string>
X-RequestId: <unique identifier>
X-ClientApplication: <client version>
<REQUEST BODY>
Server response
HTTP/1.1 200 OK
Host: <URL of the host server>
Content-Length: <length>
Content-Type: application/mapi-http
Set-Cookie: <session context cookie>=<new opaque string>
Set-Cookie: <request sequence cookie>=<new opaque string>
X-RequestType: Connect
X-RequestId: <unique identifier>
X-ResponseCode: 0
X-ClientInfo: <opaque string>
X-ServerApplicaiton: <server version>
X-ExpirationInfo: <milliseconds>
<CRLF>
PROCESSING<CRLF>
DONE<CRLF>
X-ResponseCode: 0<CRLF>
X-ElapsedTime: <milliseconds>
X-StartTime: <date/time>
<CRLF>
<RESPONSE BODY>

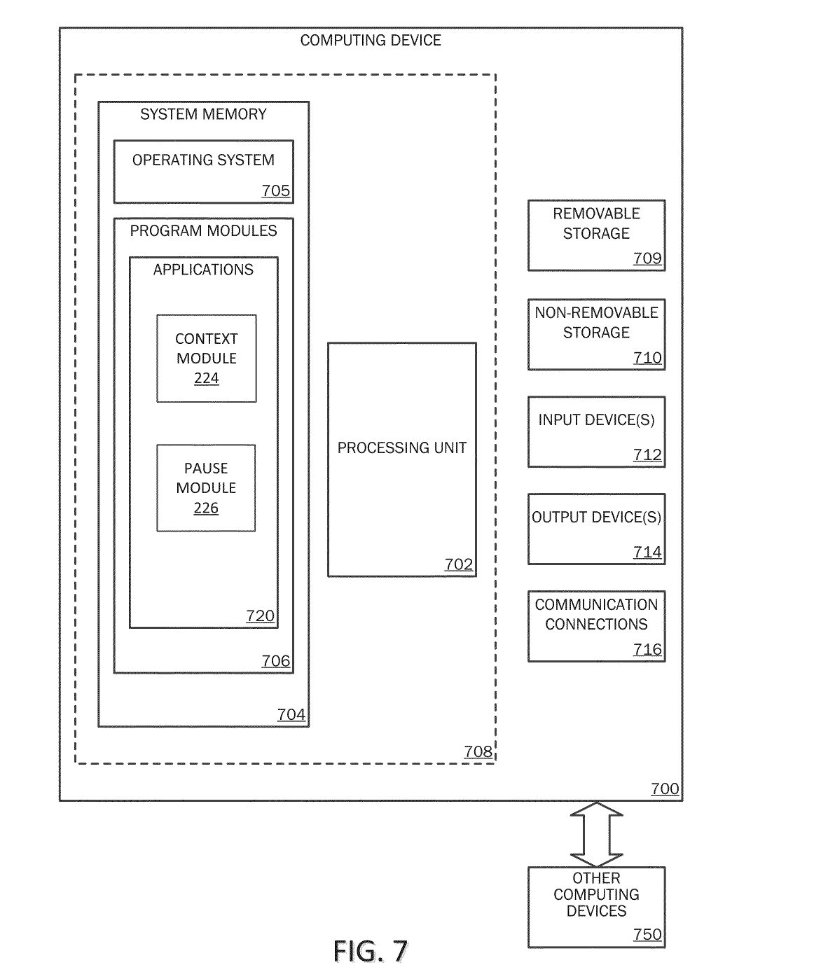

FIGS. 7-9 and the associated descriptions provide a discussion of a variety of operating environments in which embodiments of the disclosure may be practiced. However, the devices and systems illustrated and discussed with respect to FIGS. 7-9 are for purposes of example and illustration and are not limiting of a vast number of computing device configurations that may be utilized for practicing embodiments of the disclosure, described herein

FIG. 7 is a block diagram illustrating physical components (e.g., hardware) of a computing device 700 with which embodiments of the disclosure may be practiced. The computing device components described below may be suitable to act as the computing devices described above for executing the context module 224 and the pause module 228 of FIG. 2. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 720 such as maintaining a session across a period of disconnection in regards to FIGS. 2-3 and, in particular, modules 224 and 226. The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., content module 224 and pause module 226) may perform processes including, but not limited to, email applications, as described herein. Other program modules that may be used in accordance with embodiments of the present disclosure, and in particular to generate screen content, may include electronic mail and contacts applications, word processing applications, spreadsheet applications, database applications, slide presentation applications, drawing, messaging applications, and/or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

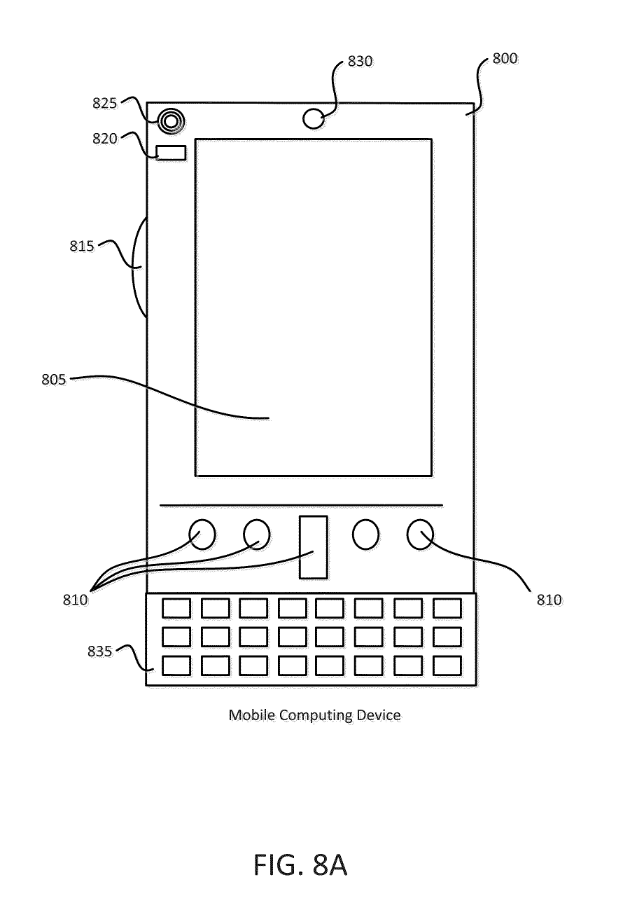

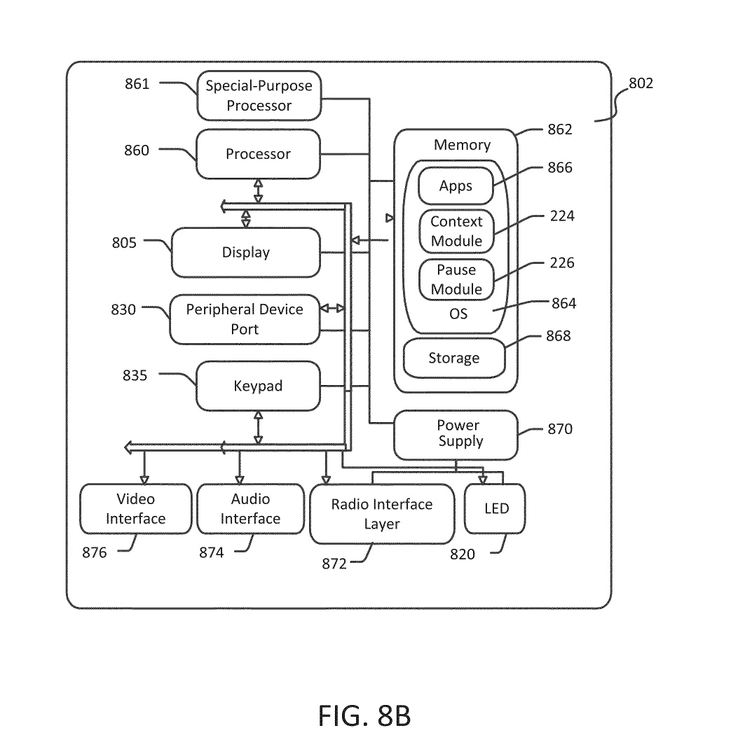

FIGS. 8A and 8B illustrate a mobile computing device 800, for example, a mobile telephone, a smart phone, wearable computer (such as a smart watch), a tablet personal computer, a laptop computer, and the like, with which embodiments of the disclosure may be practiced. With reference to FIG. 8A, one embodiment of a mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some embodiments, the mobile computing device 800 incorporates a vibration transducer for providing the user with tactile feedback. In yet another embodiment, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one embodiment of a mobile computing device. That is, the mobile computing device 800 can incorporate a system (e.g., an architecture) 802 to implement some embodiments. In one embodiment, the system 802 is implemented as a “smart phone” capable of running one or more applications (e.g., browser, e-mail, calendaring, contact managers, messaging clients, games, and media clients/players). In some embodiments, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including the capability to preserve a session across a period disconnection (and/or optionally client 202, pause module 226, and context module 224) described herein. In some analogous systems, an inverse process can be performed via system 802, in which the system acts as a remote device 120 for decoding a bitstream generated using a universal screen content codec.

The system 802 has a power supply 870, which may be implemented as one or more batteries. The power supply 870 might further include an external power source, such as an AC adapter or a powered docking cradle that supplements or recharges the batteries.

The system 802 may also include a radio 872 that performs the function of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio 872 or via a distributed computing network. Similarly, such data/information may be readily transferred between computing devices for storage and use according to well-known data/information transfer and storage means, including electronic mail and collaborative data/information sharing systems.

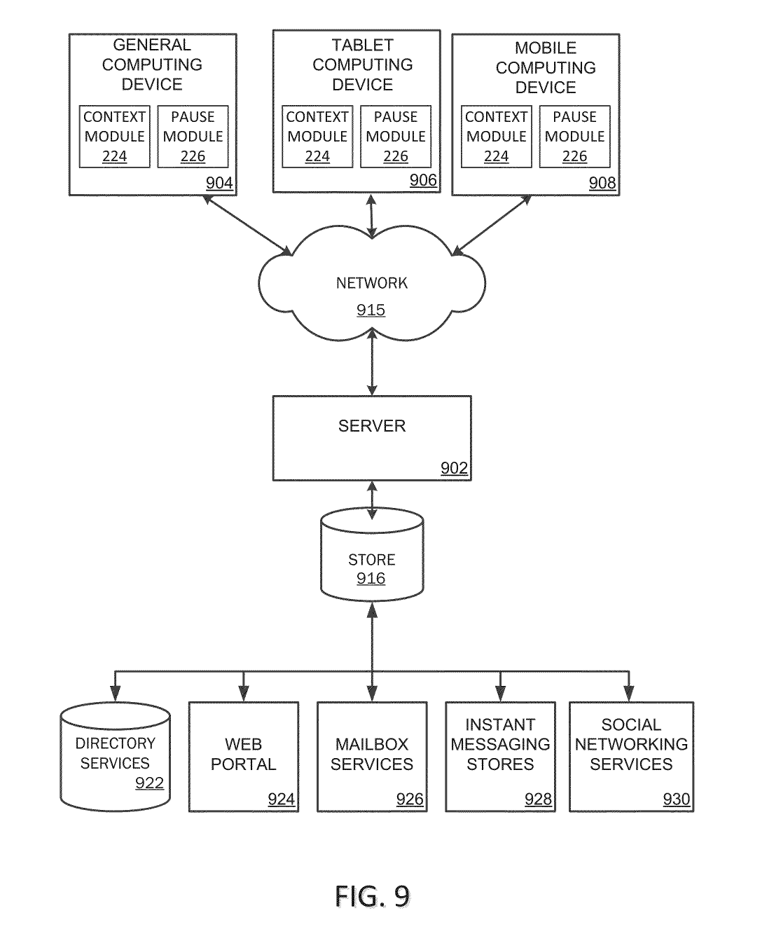

FIG. 9 illustrates one embodiment of the architecture of a system for processing data received at a computing system from a remote source, such as a computing device 904, tablet 906, or mobile device 908, as described above. Content displayed at server device 902 may be stored in different communication channels or other storage types. For example, various documents may be stored using a directory service 922, a web portal 924, a mailbox service 926, an instant messaging store 928, or a social networking site 930. The context module 224 and pause module 226 may switch a client protocol based on communication with a server 902 over the web, e.g., through a network 915. By way of example, the client computing device may be implemented as the communication service device 94 or productivity service device 96 and embodied in a personal computer 904, a tablet computing device 906 and/or a mobile computing device 908 (e.g., a smart phone). Any of these embodiments of the computing devices 94, 96, 800, 900, 902, 904, 906, 908 may obtain content from the store 916, in addition to receiving graphical data useable to be either pre-processed at a graphic-originating system, or post-processed at a receiving computing system.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the disclosure as claimed in any way. The embodiments, examples, and details provided in this application are considered sufficient to convey possession and enable others to make and use the best mode of claimed disclosure. The claimed disclosure should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed disclosure.

1. A method for maintaining a session across a period of disconnection between a client and a server to exchange data over a network, the method comprising:
determining that a disconnection between the server and the client is pause eligible based on a disconnection condition;
sending a context identifier to the server during a first reconnection attempt based on the determination; and
receiving a state of the session from the server in response to the sent context identifier.

2. The method of claim 1, prior to the determination, further comprising:
exchanging data in the session with the server over a network connection;
receiving the context identifier from the server; and
storing the context identifier.

3. The method of claim 1, wherein the receiving of the state of the session comprises:
receiving a valid state.

4. The method of claim 3, further comprising:
resuming the session based on the valid state.

5. The method of claim 4, wherein the session provides the client access to at least one resource accessed prior to the disconnection.

6. The method of claim 4, further comprises:
saving, after the resuming of the session, data edits in an application that were made and not saved before the disconnection.

7. The method of claim 1, wherein the receiving of the state of the session comprises:
receiving an invalid state.

8. The method of claim 7, further comprising:
establishing a new session during a second reconnection attempt based on the invalid state.

9. The method of claim 8, wherein the establishing of the new session comprises:
sending at least one request to access each needed resource on the server.

10. The method of claim 7, wherein the invalid state is received when the session created prior to the disconnection does not exist on the server.

11. The method of claim 1, wherein the disconnection condition is at least one of a hibernation, a change in interface, a loss of connectivity, password expiration, server-requested throttling, and no connectivity.

12. The method of claim 1, wherein the client comprises at least one of:
a mobile telephone;
a smart phone;
a tablet;
a smart watch;
a wearable computer;
a personal computer;
a desktop computer; and
a laptop computer.

13. The method of claim 1, wherein the client communicates with the server for providing data to at least one of:
an email application;
a social networking application;
a collaboration application;
an enterprise management application;
a messaging application;
a word processing application;
a spreadsheet application;
a database application;
a presentation application;
a contacts application; and
a calendaring application.

14. A system comprising:
a client for data exchange with a server executed at least in part by a computing device, the computing device comprising:
a programmable circuit;
a memory for containing computer-executable instructions, which when executed, cause the client to:
determine that a disconnection between the server and the client is pause eligible based on a disconnection condition;
send a context identifier to the server during a first reconnection attempt; and
resume a session with the server based on the receipt of a valid state of the session sent from the server in response to the context identifier.

15. The system of claim 14, wherein the data exchange is at least one of:
an email application, a social networking application, a collaboration application, an enterprise management application, a messaging application, a word processing application, a spreadsheet application, a database application, a presentation application, contacts application, and a calendaring application.

16. The system of claim 14, wherein the computer-executable instructions, which when executed, prior to the determination, further cause the client to:
exchange data in the session with the server over a network connection;
store the context identifier received from the server during the exchange of data.

17. The system of claim 16, wherein the client uses a hypertext transfer (HTTP) protocol.

18. The system of claim 17, wherein the context identifier is a cookie.

19. The system of claim 14, wherein the disconnection condition is at least one of a hibernation, a change in interface, a loss of connectivity, password expiration, server-requested throttling, and no connectivity.

20. A computer-readable storage medium comprising computer-executable instructions stored thereon which, when executed by a computing system, cause the computing system to perform a method comprising:
exchanging data in a session with a server over a network connection;
receiving a context identifier that identifies the session from the server;
storing the context identifier;
determining that a disconnection is pause eligible based on a disconnection condition, wherein the disconnection condition is at least one of a hibernation, a change in interface, a loss of connectivity, password expiration, server-requested throttling, and no connectivity;
sending the context identifier back to the server during a first reconnection attempt;
receiving a valid state of the session from the server in response to the sent context identifier; and
resuming the session, wherein the session provides access to any resource accessed prior to the disconnection.
